(19) United States
(12) Patent Application Publication
(10) Pub. No.: US 2026/0058180 A1
(43) Pub. Date: Feb. 26, 2026

(54) STATIC REDOX BATTERY AND ENERGY STORAGE SYSTEM COMPRISING SAME

(71) Applicant: XRB Co., Ltd, Anyang-si (KR)

(72) Inventors: Seung Hwan HWANG, Seongnam-si (KR); Kyong Lock NA, Suwon-si (KR)

(21) Appl. No.: 19/106,303

(22) PCT Filed: Aug. 21, 2023
(86) PCT No.: PCT/KR2023/012327

§ 371 Date: Feb. 25, 2025

(30) Foreign Application Priority Data
Aug. 25, 2022 (KR) 10-2022-0107145

(51) Int. Cl. H01M 8/18; H01M 4/86; H01M 8/0289; H01M 8/24; H01M 10/42; H01M 50/54

(52) U.S. Cl. CPC H01M 8/188; H01M 4/8615; H01M 8/0289; H01M 8/2459; H01M 10/425; H01M 50/54; H01M 2010/4271; H01M 2250/10

(57) ABSTRACT

A static redox battery includes: a membrane having an ion permeation property; a positive electrode electrolyte storage cell module positioned on one side of the membrane; a negative electrode electrolyte storage cell module positioned on the other side of the membrane; and a pair of bipolar plates positioned on outermost sides of the positive electrode electrolyte storage cell module and the negative electrode electrolyte storage cell module. Each of the positive electrode electrolyte storage cell module and the negative electrode electrolyte storage cell module includes a plurality of felt electrodes storing an electrolyte, and a plurality of perforated support plates positioned between the plurality of felt electrodes.

### TECHNICAL FIELD

### Cross-Reference to Related Application(s)

This application claims benefit of priority to Korean Patent Application No. 10-2022-0107145 filed on Aug. 25, 2022 in the Korean Intellectual Property Office, the disclosure of which is incorporated herein by reference in its entirety.

The present disclosure relates to a static redox battery, and more specifically, to a static redox battery capable of excluding a device configuration for electrolyte circulation, and an energy storage system including the same.

### BACKGROUND ART

An energy storage system (ESS) is a system that stores produced electricity in a power grid (grid energy storage) and supplies the electricity when needed to increase energy efficiency. The most widely used ESS technology at present is a lithium ion battery, which has a high storage capacity but frequently causes ignition accidents. Interest in a redox flow battery that uses an aqueous electrolyte containing water is growing to overcome such a problem.

The redox flow battery is a flow battery that performs charging and discharging using oxidation and reduction reactions of an electrolyte. The redox flow battery is safer than the lithium ion battery due to lower risks of human toxicity, flammability, and chemical reactivity and has a long lifespan of over 20 years, and a flexible capacity design of the redox flow battery achieves high applicability in the field of renewable energy generation.

However, in the redox flow battery, the oxidation and reduction reactions occur involving the electrolyte stored in an external tank, the electrolyte needs to be continuously supplied to an electrode, and thus additional devices such as a storage tank, a pipe, a valve, and a pump are necessarily required. Therefore, the existing redox flow battery has disadvantages in that installation costs are high, a large installation space is required, maintainability is low due to a complex device configuration.

### DISCLOSURE

### Technical Problem

The present disclosure attempts to provide a static redox battery that maintains advantages of an existing redox flow battery, such as fire safety, a long lifespan, and a flexible capacity design, while excluding a device configuration for electrolyte circulation to reduce installation costs, reduce a size of an installation space, and facilitate maintenance, and an energy storage system including the same.

### Technical Solution

A static redox battery according to an embodiment of the present disclosure includes: a membrane having an ion permeation property; a positive electrode electrolyte storage cell module positioned on one side of the membrane; a negative electrode electrolyte storage cell module positioned on the other side of the membrane; and a pair of bipolar plates positioned on outermost sides of the positive electrode electrolyte storage cell module and the negative electrode electrolyte storage cell module. Each of the positive electrode electrolyte storage cell module and the negative electrode electrolyte storage cell module may include a plurality of felt electrodes storing an electrolyte, and a plurality of perforated support plates positioned between the plurality of felt electrodes.

The plurality of felt electrodes may be combined in groups of at least two, and one perforated support plate may be positioned between adjacent groups of felt electrodes that are combined in groups of at least two. A plurality of through-holes may be positioned in each of the plurality of perforated support plates, and the plurality of through-holes may be aligned in one direction and positioned so as to be misaligned from each other in another direction.

Each of the plurality of perforated support plates may be formed of a composite of graphite and a polymer material and may have flexibility. Ten or more felt electrodes may be provided in each of the positive electrode electrolyte storage cell module and the negative electrode electrolyte storage cell module, and the positive electrode electrolyte storage cell module and the negative electrode electrolyte storage cell module may be symmetrical with respect to the membrane.

A static redox battery according to another embodiment of the present disclosure includes: a membrane having an ion permeation property; a positive electrode electrolyte storage cell module positioned on one side of the membrane; a negative electrode electrolyte storage cell module positioned on the other side of the membrane; and a pair of bipolar plates positioned on outermost sides of the positive electrode electrolyte storage cell module and the negative electrode electrolyte storage cell module. Each of the positive electrode electrolyte storage cell module and the negative electrode electrolyte storage cell module may include a plurality of felt electrodes storing an electrolyte, a plurality of perforated support plates positioned between the plurality of felt electrodes, and a plurality of outer frames and a plurality of inner frames fixing the plurality of felt electrodes and the plurality of perforated support plates. The plurality of outer frames may be combined in an interlocking compression method to confine the electrolyte in the outer frames.

In each of the positive electrode electrolyte storage cell module and the negative electrode electrolyte storage cell module, the plurality of perforated support plates and the bipolar plate may be electrically connected to each other by a conductive portion.

In the positive electrode electrolyte storage cell module, the plurality of felt electrodes may be connected to a positive electrode electrolyte supply line to receive a positive electrode electrolyte and store the positive electrode electrolyte by confining the positive electrode electrolyte in internal pores. In the negative electrode electrolyte storage cell module, the plurality of felt electrodes may be connected to a negative electrode electrolyte supply line to receive a negative electrode electrolyte and store the negative electrode electrolyte by confining the negative electrode electrolyte in internal pores.

A plurality of through-holes may be positioned in each of the plurality of perforated support plates, the plurality of felt electrodes may be combined in groups of at least two, and one perforated support plate may be positioned between adjacent groups of felt electrodes that are combined in groups of at least two. The pair of bipolar plates and the plurality of perforated support plates may be formed of a composite of graphite and a polymer material and may have flexibility.

In each of the positive electrode electrolyte storage cell module and the negative electrode electrolyte storage cell module, a plurality of sets of the outer frame, the felt electrode, the inner frame, the felt electrode, and the perforated support plate that are sequentially stacked may be stacked, and two felt electrodes positioned with the inner frame interposed therebetween may be combined with each other.

Each of the plurality of outer frames may have a concave structural surface and a convex structural surface that is a surface opposite to the concave structural surface, and may further have a conductive connection portion provided at an inner edge surrounding a central opening. The conductive connection portion may be in contact with one of the perforated support plate and the bipolar plate, and a plurality of conductive connection portions may be in close contact with each other in each of the positive electrode electrolyte storage cell module and the negative electrode electrolyte storage cell module to conduct electricity between the plurality of perforated support plates and the bipolar plate.

The plurality of outer frames may include a first outer frame belonging to the positive electrode electrolyte storage cell module and having a first conductive connection portion, a second outer frame belonging to the negative electrode electrolyte storage cell module and having a second conductive connection portion, and a third outer frame that is in contact with the bipolar plate and having a third conductive connection portion.

The first outer frame may include a positive-electrode-electrolyte lower manifold introducing portion, a positive-electrode-electrolyte upper manifold introducing portion, a positive-electrode-electrolyte guide channel, a negative-electrode-electrolyte lower manifold blocking portion, and a negative-electrode-electrolyte upper manifold blocking portion. The second outer frame may include a negative-electrode-electrolyte lower manifold introducing portion, a negative-electrode-electrolyte upper manifold introducing portion, a negative-electrode-electrolyte guide channel, a positive-electrode-electrolyte lower manifold blocking portion, and a positive-electrode-electrolyte upper manifold blocking portion.

The bipolar plate fixed to the third outer frame may have one surface facing the same direction as the concave structural surface, and a negative electrode electrolyte may be positioned on the one surface of the bipolar plate. The bipolar plate fixed to the third outer frame may have the other surface facing the same direction as the convex structural surface, and a positive electrode electrolyte may be positioned on the other surface of the bipolar plate.

An energy storage system according to an embodiment of the present disclosure includes: the static redox battery having the above-described configuration; a battery management system monitoring and managing a state of the static redox battery; a power conditioning system receiving power from a power source and converting characteristics of electricity to store electric energy in the static redox battery and release the electric energy stored in the static redox battery to a grid; and an energy management system electrically controlling the static redox battery and the power conditioning system.

### Advantageous Effects

The static redox battery according to the present disclosure does not use a device configuration required for electrolyte circulation, and thus, it is possible to reduce an installation cost, reduce a size of an installation space, and facilitate maintenance. In addition, the static redox battery has no limitation on the number of felt electrodes, and thus, an energy capacity may be greatly increased, and various outputs and energy capacities may be easily implemented. The energy storage system including the static redox battery may contribute to stable power supply in conjunction with new and renewable energy, and may be widely applied to buildings, ships, electric vehicle charging stations, and the like.

### DESCRIPTION OF THE DRAWINGS

FIG. 1 is a configuration view of a static redox battery according to an embodiment of the present disclosure;

FIG. 2 is a partial exploded plan view illustrating a part of the static redox battery illustrated in FIG. 1;

FIG. 3 is a plan view of a perforated support plate in the static redox battery illustrated in FIG. 1;

FIG. 4 is a configuration view illustrating a first surface of an outer frame belonging to a positive electrode electrolyte storage cell module in the static redox battery illustrated in FIG. 1;

FIG. 5 is a configuration view illustrating a second surface of the outer frame belonging to the positive electrode electrolyte storage cell module in the static redox battery illustrated in FIG. 1;

FIG. 6 is a configuration view illustrating a first surface of an outer frame belonging to a negative electrode electrolyte storage cell module in the static redox battery illustrated in FIG. 1;

FIG. 7 is a configuration view illustrating a second surface of the outer frame belonging to the negative electrode electrolyte storage cell module in the static redox battery illustrated in FIG. 1;

FIG. 8 is a configuration view illustrating a first surface of an outer frame that is in contact with a bipolar plate in the static redox battery illustrated in FIG. 1;

FIG. 9 is a configuration view illustrating a second surface of the outer frame that is in contact with the bipolar plate in the static redox battery illustrated in FIG. 1; and

FIG. 10 is a configuration diagram of an energy storage system according to an embodiment of the present disclosure.

### MODE FOR INVENTION

The present disclosure will be described more fully hereinafter with reference to the accompanying drawings, in which embodiments of the present disclosure are shown. As those skilled in the art would realize, the described embodiments may be modified in various different ways, all without departing from the spirit or scope of the present disclosure.

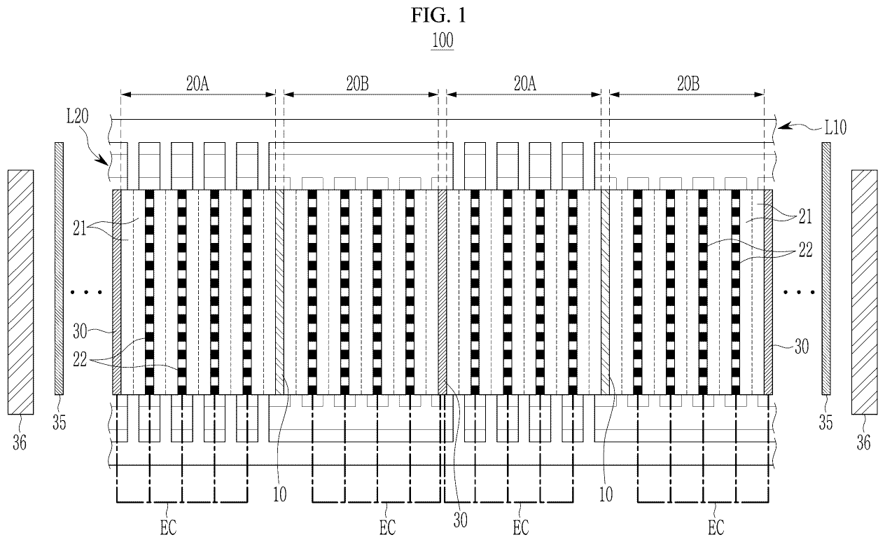

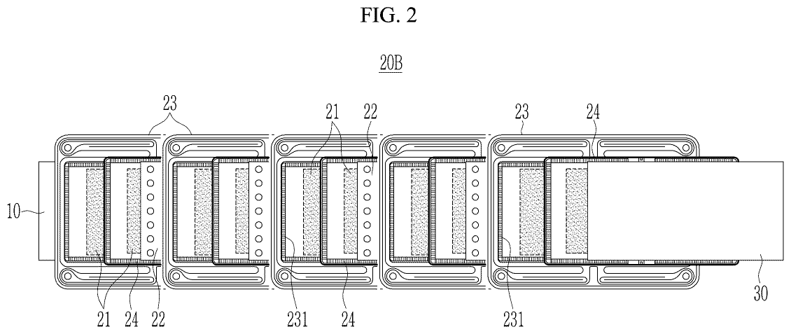

FIG. 1 is a configuration view of a static redox battery according to an embodiment of the present disclosure. FIG. 2 is a partial exploded plan view illustrating a part of the static redox battery illustrated in FIG. 1.

Referring to FIGS. 1 and 2, in a static redox battery 100 according to an embodiment, unlike an existing redox flow battery, an electrolyte does not circulate between a cell stack and an external tank during operation, the electrolyte supplied in advance before the operation may be confined and stored therein, and charging and discharging may be performed by causing a battery reaction using the stored electrolyte.

The static redox battery 100 may include a membrane 10, a positive electrode electrolyte storage cell module 20A positioned on one side of the membrane 10, a negative electrode electrolyte storage cell module 20B positioned on the other side of the membrane 10, and bipolar plates 30 positioned on the outermost sides of the positive electrode electrolyte storage cell module 20A and the negative electrode electrolyte storage cell module 20B. The positive electrode electrolyte storage cell module 20A and the negative electrode electrolyte storage cell module 20B may be horizontally symmetrical with respect to the membrane 10.

The membrane 10, the positive electrode electrolyte storage cell module 20A, the negative electrode electrolyte storage cell module 20B, and the pair of bipolar plates 30 may form one battery cell, and the static redox battery 100 may have a configuration in which a plurality of battery cells are arranged in series as illustrated in FIG. 1.

The membrane 10 may be a hydrogen ion permeable membrane, and a thickness of the membrane 10 may be approximately 25 μm to 200 μm. The bipolar plate 30 may function as a current collector that collects a current from the battery cell, and the positive electrode electrolyte storage cell module 20A and the negative electrode electrolyte storage cell module 20B arranged in series may share one bipolar plate 30.

A pair of current collectors 35 and a pair of end plates 36 may be positioned on the outermost sides of the plurality of battery cells arranged in series, and the plurality of battery cells, the pair of current collectors 35, and the pair of end plates 36 may be compressed by an external pressure to form a cell stack. The current collector 35 may be a lead electrode that collects the current collected on the bipolar plate 30 of each battery cell and is connected to an external circuit. The end plate 36 may be electrically insulated from the current collector 35 and function as a support plate that mechanically fastens and fixes the cell stack.

The positive electrode electrolyte storage cell module 20A and the negative electrode electrolyte storage cell module 20B may have the same mechanical configuration except that the electrolytes confined therein are a positive electrode electrolyte and a negative electrode electrolyte, respectively.

Specifically, the positive electrode electrolyte storage cell module 20A and the negative electrode electrolyte storage cell module 20B may each include a plurality of felt electrodes 21 confining the electrolyte, a plurality of perforated support plates 22 positioned between the plurality of felt electrodes 21, and a plurality of outer frames 23 and a plurality of inner frames 24 forming a sealing structure to prevent leakage of the electrolyte and fixing the plurality of felt electrodes 21 and the plurality of perforated support plates 22.

The felt electrode 21 may be formed of a conductive porous material such as carbon felt and may store the electrolyte by containing the electrolyte in internal pores thereof. An initial thickness of the felt electrode 21 may be approximately 4.5 mm to 5.5 mm, and a thickness of the felt electrode 21 after cell stack assembly by compression may be reduced by approximately 20% to 25% compared to the initial thickness.

In each of the positive electrode electrolyte storage cell module 20A and the negative electrode electrolyte storage cell module 20B, as the number of felt electrodes 21 is increased, a volumetric capacity of the electrolyte and an energy capacity of the static redox battery 100 may be increased. FIG. 1 illustrates a case where each of the positive electrode electrolyte storage cell module 20A and the negative electrode electrolyte storage cell module 20B includes 10 felt electrodes 21 as an example, but the number of felt electrodes 21 is not limited to that in the illustrated example.

The plurality of felt electrodes 21 may be combined in groups of at least two to reduce an electrical contact resistance between the felt electrodes 21, and one perforated support plate 22 may be positioned between adjacent groups of felt electrodes 21 that are combined in groups of at least two. FIGS. 1 and 2 illustrate a case where the felt electrodes 21 are combined in groups of two as an example. The perforated support plate 22 may be formed using a conductive plate having a plurality of through-holes and may be compressed together with the plurality of felt electrodes 21 to reduce the electrical contact resistance between adjacent felt electrodes 21.

The perforated support plate 22 may function as a support that supports adjacent felt electrodes 21 such that the respective felt electrodes 21 may have a uniform thickness and receive a uniform fastening pressure when the plurality of felt electrodes 21 are compressed. At this time, the perforated support plate 22 may have flexibility and may have the same material and thickness as the bipolar plate 30. In addition, the perforated support plate 22 may facilitate diffusion of the electrolyte and hydrogen ions through the plurality of through-holes.

For example, the bipolar plate 30 and the perforated support plate 22 may be formed of a composite of graphite and a polymer material having excellent electrical conductivity and chemical resistance and high mechanical strength and flexibility. Each of the bipolar plate 30 and the perforated support plate 22 may have a thickness of approximately 0.5 mm to 1 mm.

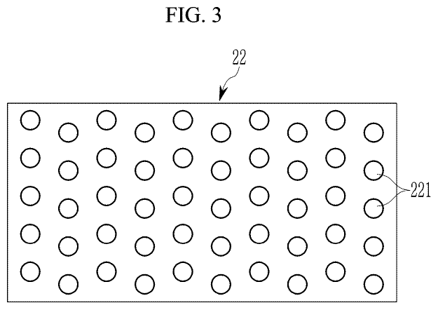

FIG. 3 is a plan view of the perforated support plate in the static redox battery illustrated in FIG. 1.

Referring to FIG. 3, a plurality of through-holes 221 provided in the perforated support plate 22 may be circular, and an aperture ratio of the perforated support plate 22 may be approximately 5% to 95%. A diameter of the through-hole 221 and an interval between the through-holes 221 may be appropriately adjusted according to the aperture ratio.

The plurality of through-holes 221 may be aligned in a vertical direction, and the through-holes 221 of any one column may be positioned so as to be misaligned from the through-holes 221 of an adjacent column. On the other hand, the plurality of through-holes 221 may be aligned in a horizontal direction, and the through-holes 221 of any one row may be positioned so as to be misaligned from the through-holes 221 of an adjacent row. FIG. 3 illustrates the former case as an example.

Referring back to FIGS. 1 and 2, the plurality of outer frames 23 and the plurality of inner frames 24 may surround and fix the plurality of felt electrodes 21 and the plurality of perforated support plates 22, and form the sealing structure to prevent the leakage of the electrolyte. At this time, an uneven structure may be provided on the outer frame 23, so that the outer frame 23 may be fitted into an adjacent outer frame 23 in a protrusion-groove manner to seal an electrolyte space. In other words, the plurality of outer frames 23 may be combined in an interlocking compression manner to form the cell stack.

For example, the negative electrode electrolyte storage cell module 20B may have a configuration in which the outer frame 23, the felt electrode 21, the inner frame 24, the felt electrode 21, and the perforated support plate 22 form one set, four sets are stacked in series, and then the outer frame 23, the felt electrode 21, the inner frame 24, the felt electrode 21, and the bipolar plate 30 are stacked as illustrated in FIG. 2.

The positive electrode electrolyte storage cell module 20A may have a configuration in which the outer frame 23, the felt electrode 21, the inner frame 24, the felt electrode 21, and the perforated support plate 22 form one set, four sets are stacked in series on the bipolar plate 30, and then the outer frame 23, the felt electrode 21, the inner frame 24, and the felt electrode 21 are stacked. A stacking order is not limited to the above-described example. The number of stacked sets is not limited, and tens of sets may be stacked.

Two felt electrodes 21 positioned with the inner frame 24 interposed therebetween may be combined with each other. The plurality of felt electrodes 21 and the plurality of perforated support plates 22 may be combined to each other inside the cell stack by mutual compression of the plurality of outer frames 23 and the plurality of inner frames 24. The positive electrode electrolyte and the negative electrode electrolyte may be positioned while being thoroughly separated from each other inside the cell stack and may not mix with each other inside the cell stack.

The outer frame 23 may be formed to be larger than the felt electrode 21, the perforated support plate 22, the bipolar plate 30, and the membrane 10, and a central opening 231 of the outer frame 23 may be formed to be smaller than the felt electrode 21, the perforated support plate 22, the bipolar plate 30, and the membrane 10. The inner frame 24 may be formed to be larger than the central opening 231 of the outer frame 23 and may be positioned so as to overlap the outer frame 23. The outer frame 23 and the inner frame 24 may contain polypropylene or a similar polymer material and may be produced by injection molding.

In each of the positive electrode electrolyte storage cell module 20A and the negative electrode electrolyte storage cell module 20B illustrated in FIG. 1, the plurality of perforated support plates 22 and the bipolar plate 30 may be electrically connected to each other by a conductive portion EC. A function of the conductive portion EC may be implemented by first to third conductive connection portions 25A to 25C described below.

In the positive electrode electrolyte storage cell module 20A illustrated in FIG. 1, the plurality of felt electrodes 21 may be connected to a positive electrode electrolyte supply line L10 to receive the positive electrode electrolyte therefrom and store the supplied positive electrode electrolyte. In the negative electrode electrolyte storage cell module 20B illustrated in FIG. 1, the plurality of felt electrodes 21 may be connected to a negative electrode electrolyte supply line L20 to receive the negative electrode electrolyte therefrom and store the supplied negative electrode electrolyte. Configurations of the positive electrode electrolyte supply line L10 and the negative electrode electrolyte supply line L20, and supply paths of the positive electrode electrolyte and the negative electrode electrolyte are described below.

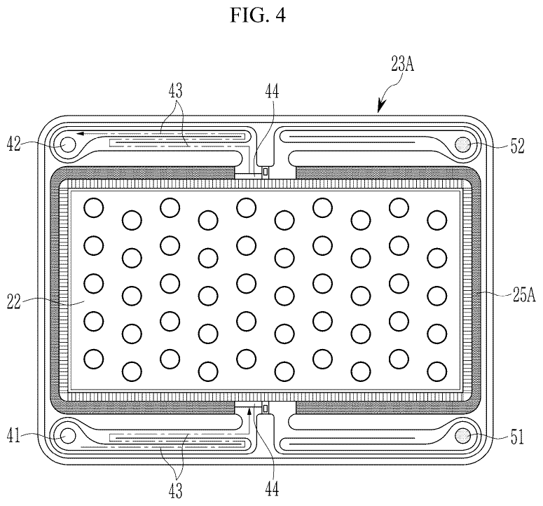

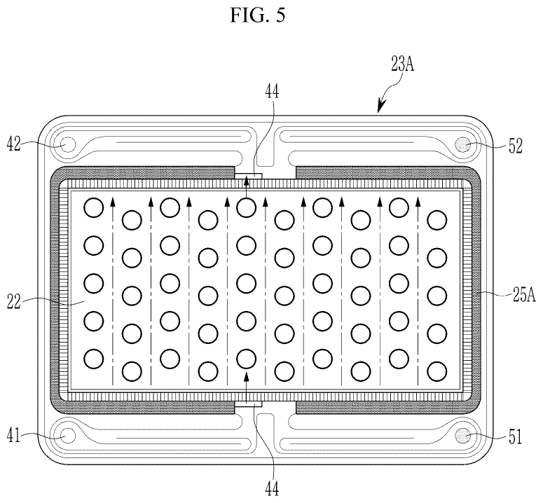

FIG. 4 is a configuration view illustrating a first surface of the outer frame belonging to the positive electrode electrolyte storage cell module in the static redox battery illustrated in FIG. 1. FIG. 5 is a configuration view illustrating a second surface of the outer frame belonging to the positive electrode electrolyte storage cell module in the static redox battery illustrated in FIG. 1. For convenience, the outer frame 23 belonging to the positive electrode electrolyte storage cell module 20A may be referred to as a “first outer frame 23A”.

The first surface of the first outer frame 23A may be referred to as a concave structural surface or a front surface, and a second surface of the first outer frame 23A may be referred to as a convex structural surface or a back surface. The concave structural surface may be a surface that is basically concave and has a guide channel for electrolyte movement and a partially convex protrusion for interlocking, and the convex structural surface may be a surface opposite to the concave structural surface.

Referring to FIGS. 4 and 5, two electrolyte introducing portions 41 and 42 and two electrolyte blocking portions 51 and 52 may be positioned at four corners of the first outer frame 23A. The two electrolyte introducing portions 41 and 42 may have a hole shape and may include the positive-electrode-electrolyte lower manifold introducing portion 41 and the positive-electrode-electrolyte upper manifold introducing portion 42. The two electrolyte blocking portions 51 and 52 may be closed and may include the negative-electrode-electrolyte lower manifold blocking portion 51 and the negative-electrode-electrolyte upper manifold blocking portion 52.

The two electrolyte introducing portions 41 and 42 may be connected to two positive-electrode-electrolyte guide channels 43 and two positive-electrode-electrolyte gates 44 formed on the first surface. The two positive-electrode-electrolyte gates 44 may have a hole shape.

Before operation of the static redox battery 100, the positive electrode electrolyte may be introduced into and stored in the felt electrode 21 of the second surface through the positive-electrode-electrolyte lower manifold introducing portion 41, the positive-electrode-electrolyte guide channel 43 on a lower side, and the positive-electrode-electrolyte gate 44 on the lower side. The positive electrode electrolyte may move upward and then move along the positive-electrode-electrolyte guide channel 43 on an upper side of the first surface and the positive-electrode-electrolyte upper manifold introducing portion 42 through the positive-electrode-electrolyte gate 44 on the upper side. During the operation of the static redox battery 100, the positive electrode electrolyte may maintain a state of being stored in the plurality of felt electrodes 21 without movement.

At this time, the first conductive connection portion 25A having a band shape may be provided at an inner edge surrounding the central opening in the first outer frame 23A. The first conductive connection portion 25A may be formed of a conductive metal such as copper or aluminum, and may be in contact with the perforated support plate 22. In the compressed positive electrode electrolyte storage cell module 20A, a plurality of first conductive connection portions 25A may be in close contact with each other to ensure electrical connection between the plurality of perforated support plates 22.

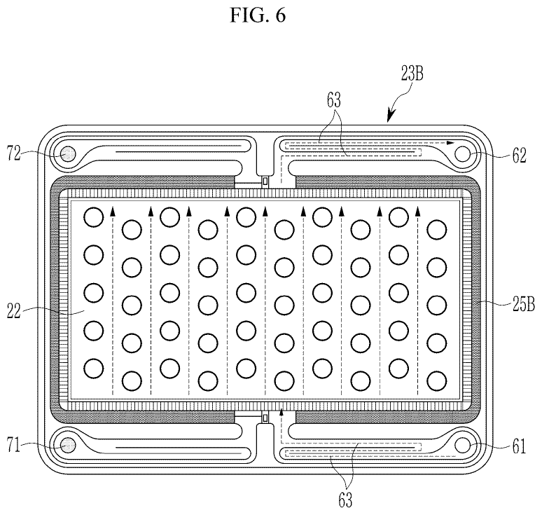

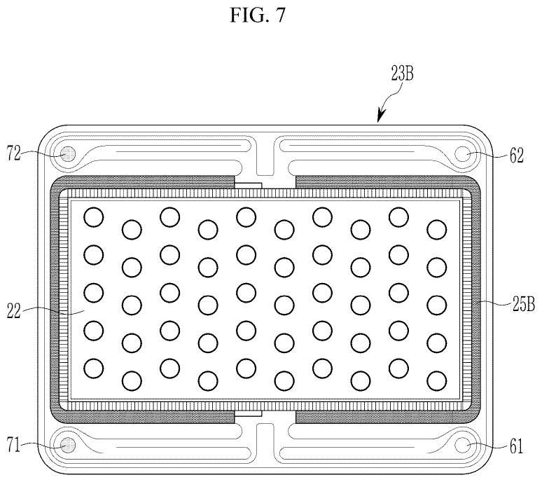

FIG. 6 is a configuration view illustrating a first surface of the outer frame belonging to the negative electrode electrolyte storage cell module in the static redox battery illustrated in FIG. 1. FIG. 7 is a configuration view illustrating a second surface of the outer frame belonging to the negative electrode electrolyte storage cell module in the static redox battery illustrated in FIG. 1. For convenience, the outer frame 23 belonging to the negative electrode electrolyte storage cell module 20B may be referred to as a “second outer frame 23B”. Since the first surface and the second surface are the same as those defined in the first outer frame 23A, an overlapping description is omitted.

Referring to FIGS. 6 and 7, two electrolyte introducing portions 61 and 62 and two electrolyte blocking portions 71 and 72 may be positioned at four corners of the second outer frame 23B. The two electrolyte introducing portions 61 and 62 may have a hole shape and may include the negative-electrode-electrolyte lower manifold introducing portion 61 and the negative-electrode-electrolyte upper manifold introducing portion 62. The two electrolyte blocking portions 71 and 72 may be closed and may include the positive-electrode-electrolyte lower manifold blocking portion 71 and the positive-electrode-electrolyte upper manifold blocking portion 72.

The two electrolyte introducing portions 61 and 62 may be connected to two negative-electrode-electrolyte guide channels 63 formed on the first surface. Before the operation of the static redox battery 100, the negative electrode electrolyte may be introduced into and stored in the felt electrode 21 of the first surface through the negative-electrode-electrolyte lower manifold introducing portion 61 and the negative-electrode-electrolyte guide channel 63 on a lower side. The negative electrode electrolyte may move upward and then move along the negative-electrode-electrolyte guide channel 63 on an upper side and the negative-electrode-electrolyte upper manifold introducing portion 62. During the operation of the static redox battery 100, the negative electrode electrolyte may maintain a state of being stored in the plurality of felt electrodes 21 without movement.

At this time, the second conductive connection portion 25B having a band shape may be provided at an inner edge surrounding the central opening in the second outer frame 23B. The second conductive connection portion 25B may be formed of a conductive metal such as copper or aluminum, and may be in contact with the perforated support plate 22. In the compressed negative electrode electrolyte storage cell module 20B, a plurality of second conductive connection portions 25B may be in close contact with each other to ensure electrical connection between the plurality of perforated support plates 22.

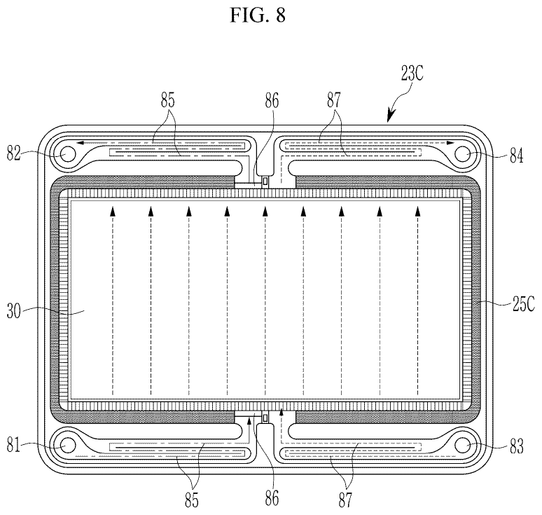

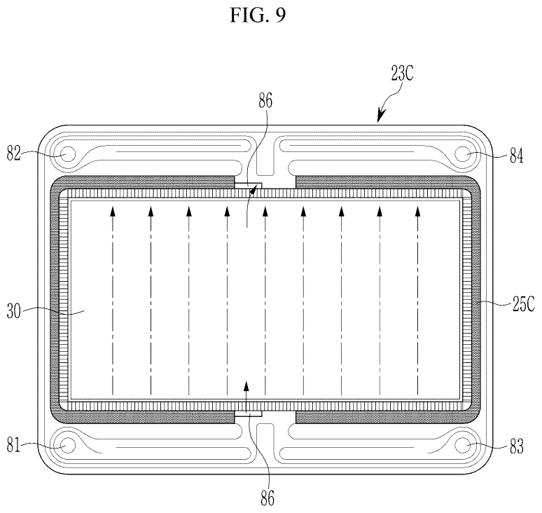

FIG. 8 is a configuration view illustrating a first surface of the outer frame that is in contact with the bipolar plate in the static redox battery illustrated in FIG. 1. FIG. 9 is a configuration view illustrating a second surface of the outer frame that is in contact with the bipolar plate in the static redox battery illustrated in FIG. 1. At this time, the bipolar plate may mean the bipolar plate other than the bipolar plate positioned on the outermost side of the entire cell stack, that is, the bipolar plate 30 positioned between the positive electrode electrolyte storage cell module 20A and the negative electrode electrolyte storage cell module 20B.

For convenience, the outer frame 23 that is in contact with the bipolar plate 30 other than the outermost bipolar plate of the cell stack may be referred to as a “third outer frame 23C”. Since the first surface and the second surface are the same as those defined in the first outer frame 23A, an overlapping description is omitted.

Referring to FIGS. 8 and 9, four electrolyte introducing portions 81 to 84 may be positioned at four corners of the third outer frame 23C. The four electrolyte introducing portions 81 to 84 may have a hole shape and may include the positive-electrode-electrolyte lower manifold introducing portion 81, the positive-electrode-electrolyte upper manifold introducing portion 82, the negative-electrode-electrolyte lower manifold introducing portion 83, and the negative-electrode-electrolyte upper manifold introducing portion 84.

The two positive-electrode-electrolyte introducing portions 81 and 82 may be connected to two positive-electrode-electrolyte guide channels 85 and two positive-electrode-electrolyte gates 86 formed on the first surface. The two positive-electrode-electrolyte gates 86 may have a hole shape. The two negative-electrode-electrolyte introducing portions 83 and 84 may be connected to two negative-electrode-electrolyte guide channels 87 formed on the first surface.

Before the operation of the static redox battery 100, the positive electrode electrolyte may be introduced into a back surface (which is parallel to the second surface) of the bipolar plate 30 through the positive-electrode-electrolyte lower manifold introducing portion 81, the positive-electrode-electrolyte guide channel 85 on a lower side, and the positive-electrode-electrolyte gate 86 on the lower side. The positive electrode electrolyte may move upward and then move along the positive-electrode-electrolyte guide channel 85 on an upper side of the first surface and the positive-electrode-electrolyte upper manifold introducing portion 82 through the positive-electrode-electrolyte gate 86 on the upper side.

The negative electrode electrolyte may be introduced into one surface (which faces the same direction as the first surface) of the bipolar plate 30 through the negative-electrode-electrolyte lower manifold introducing portion 83 and the negative-electrode-electrolyte guide path 87 of the first surface. The negative electrode electrolyte may move upward and then move along the negative-electrode-electrolyte guide channel 87 of the first surface and the negative-electrode-electrolyte upper manifold introducing portion 84. During the operation of the static redox battery 100, the positive electrode electrolyte and the negative electrode electrolyte may maintain a state of being stored in the respective felt electrodes 21 without movement.

At this time, the third conductive connection portion 25C having a band shape may be provided at an inner edge surrounding the central opening in the third outer frame 23C. The third conductive connection portion 25B may be formed of a conductive metal such as copper or aluminum, and may be in contact with the bipolar plate 30. In the compressed cell stack, the third conductive connection portion 25C may be in close contact with the adjacent first conductive connection portion 25A and the adjacent second conductive connection portion 25B to ensure electrical connection between the bipolar plate 30 and the perforated support plates 22.

Meanwhile, the bipolar plate 30 mounted on the third outer frame 23C may have one surface facing the same direction as the first surface (concave structural surface) of the third outer frame 23C and the other surface facing the same direction as the second surface (convex structural surface) of the third outer frame 23C. The electrolyte that is in contact with the one surface of the bipolar plate 30 may be the negative electrode electrolyte (see FIG. 8), and the electrolyte that is in contact with the other surface of the bipolar plate 30 may be the positive electrode electrolyte (see FIG. 9).

A reason why the negative electrode electrolyte needs to be in contact with the one surface of the bipolar plate 30 may be that when a polarity of the electrolyte becomes negative during a charging reaction of the cell stack, the one surface of the bipolar plate 30 that is in contact with the negative electrode electrolyte also acts as a negative electrode. In a case where it is assumed that the positive electrode electrolyte is in contact with the one surface of the bipolar plate 30, a reaction in which the bipolar plate 30 is decomposed by a positive electrode reaction may occur at a part of the bipolar plate 30, which may cause a failure of the cell stack. Therefore, polarity distinction of the static redox battery 100 may be an important measure to prevent the failure of the cell stack.

Referring back to FIG. 1, the static redox battery 100 may use a vanadium electrolyte, and in this case, a rated voltage of the battery cell may be 1.2 V, which is the same as that of the existing redox flow battery. At this time, a capacity of the electrolyte confined in the static redox battery 100 is increased in proportion to the number of stacked positive electrode electrolyte storage cell modules 20A and negative electrode electrolyte storage cell modules 20B, so that the energy capacity may be significantly increased, unlike the existing redox flow battery.

In addition, in the existing redox flow battery, one felt electrode may be disposed on each side of the membrane, but in the static redox battery 100, the plurality of felt electrodes 21 may be disposed in each of the positive electrode electrolyte storage cell module 20A and the negative electrode electrolyte storage cell module 20B without limitation. Therefore, a volume of the electrolyte may be easily increased in proportion to the number of felt electrodes 21, and the static redox battery 100 that does not use a pump may be implemented.

The number of each of the positive electrode electrolyte storage cell module 20A and the negative electrode electrolyte storage cell module 20B may be 10, 20, or more. For example, the static redox battery 100 may include 10 positive electrode electrolyte storage cell modules 20A and 10 negative electrode electrolyte storage cell modules 20B, and in this case, a rated voltage of 12 V may be implemented. The static redox battery 100 may easily implement high outputs such as 24 V, 48 V, 96 V, and 192 V in addition to 12 V by increasing the number of positive electrode electrolyte storage cell modules 20A and negative electrode electrolyte storage cell modules 20B.

In addition, the static redox battery 100 may implement a rated voltage of 12 V and may implement a rated voltage of 3.0 KW and an energy capacity of 6.0 kWh when an active area of 2500 cm² and a current density of 100 mA/cm² are applied. Since the static redox battery 100 has no limitations on the number of positive electrode electrolyte storage cell modules 20A and negative electrode electrolyte storage cell modules 20B, the active area and size of the felt electrode 21, and the like, it is possible to easily implement various outputs and energy capacities.

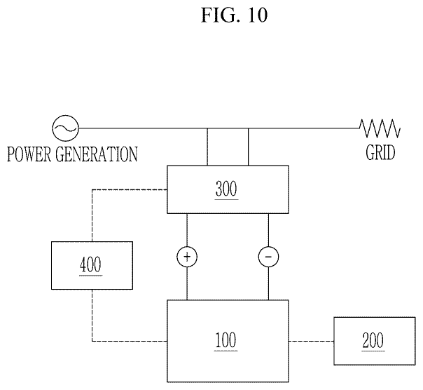

FIG. 10 is a configuration diagram of an energy storage system according to an embodiment of the present disclosure.

Referring to FIG. 10, the static redox battery 100 described above may be combined with a battery management system 200, a power conditioning system 300, and an energy management system 400 to form an energy storage system.

The battery management system 200 may monitor a state of the static redox battery 100, such as a capacity and a predicted lifespan of the static redox battery 100, and may manage the static redox battery 100 such that the static redox battery 100 may be used under optimal conditions. The power conditioning system 300 may receive power from a power source and convert characteristics (a frequency, a voltage, AC/DC, or the like) of electricity to store the power in the static redox battery 100 or to release the power stored in the static redox battery 100 to a grid. The energy management system 400 may control the static redox battery 100 and the power conditioning system 300 such that the energy storage system may be efficiently and economically operated.

The energy storage system may be used for emergency power supply, peak reduction, and frequency control, and may contribute to stable power supply in conjunction with new and renewable power generation devices such as a wind power generation device and a solar power generation device.

Although the embodiment of the present disclosure has been described above, the present disclosure is not limited thereto, and it is possible to carry out various modifications within the scope of the claims, the detailed description of the disclosure, and the accompanying drawings. It goes without saying that the modifications fall within the scope of the present disclosure.

1. A static redox battery comprising:
a membrane having an ion permeation property;
a positive electrode electrolyte storage cell module positioned on one side of the membrane;
a negative electrode electrolyte storage cell module positioned on the other side of the membrane; and
a pair of bipolar plates positioned on outermost sides of the positive electrode electrolyte storage cell module and the negative electrode electrolyte storage cell module,
wherein each of the positive electrode electrolyte storage cell module and the negative electrode electrolyte storage cell module includes a plurality of felt electrodes storing an electrolyte, and a plurality of perforated support plates positioned between the plurality of felt electrodes.

2. The static redox battery of claim 1, wherein
the plurality of felt electrodes are combined in groups of at least two, and one perforated support plate is positioned between adjacent groups of felt electrodes that are combined in groups of at least two.

3. The static redox battery of claim 2, wherein
a plurality of through-holes are positioned in each of the plurality of perforated support plates, and the plurality of through-holes are aligned in one direction and positioned so as to be misaligned from each other in another direction.

4. The static redox battery of claim 3, wherein
each of the plurality of perforated support plates is formed of a composite of graphite and a polymer material and has flexibility.

5. The static redox battery of claim 3, wherein
ten or more felt electrodes are provided in each of the positive electrode electrolyte storage cell module and the negative electrode electrolyte storage cell module, and the positive electrode electrolyte storage cell module and the negative electrode electrolyte storage cell module are symmetrical with respect to the membrane.

6. A static redox battery comprising:
a membrane having an ion permeation property;
a positive electrode electrolyte storage cell module positioned on one side of the membrane;
a negative electrode electrolyte storage cell module positioned on the other side of the membrane; and
a pair of bipolar plates positioned on outermost sides of the positive electrode electrolyte storage cell module and the negative electrode electrolyte storage cell module,
wherein each of the positive electrode electrolyte storage cell module and the negative electrode electrolyte storage cell module includes a plurality of felt electrodes storing an electrolyte, a plurality of perforated support plates positioned between the plurality of felt electrodes, and a plurality of outer frames and a plurality of inner frames fixing the plurality of felt electrodes and the plurality of perforated support plates, and
the plurality of outer frames are combined in an interlocking compression method to confine the electrolyte in the outer frames.

7. The static redox battery of claim 6, wherein
in each of the positive electrode electrolyte storage cell module and the negative electrode electrolyte storage cell module, the plurality of perforated support plates and the bipolar plate are electrically connected to each other by a conductive portion.

8. The static redox battery of claim 7, wherein
in the positive electrode electrolyte storage cell module, the plurality of felt electrodes are connected to a positive electrode electrolyte supply line to receive a positive electrode electrolyte and store the positive electrode electrolyte by confining the positive electrode electrolyte in internal pores.

9. The static redox battery of claim 7, wherein
in the negative electrode electrolyte storage cell module, the plurality of felt electrodes are connected to a negative electrode electrolyte supply line to receive a negative electrode electrolyte and store the negative electrode electrolyte by confining the negative electrode electrolyte in internal pores.

10. The static redox battery of claim 6, wherein
a plurality of through-holes are positioned in each of the plurality of perforated support plates, the plurality of felt electrodes are combined in groups of at least two, and one perforated support plate is positioned between adjacent groups of felt electrodes that are combined in groups of at least two.

11. The static redox battery of claim 10, wherein
the pair of bipolar plates and the plurality of perforated support plates are formed of a composite of graphite and a polymer material and have flexibility.

12. The static redox battery of claim 6, wherein
in each of the positive electrode electrolyte storage cell module and the negative electrode electrolyte storage cell module, a plurality of sets of the outer frame, the felt electrode, the inner frame, the felt electrode, and the perforated support plate that are sequentially stacked are stacked, and two felt electrodes positioned with the inner frame interposed therebetween are combined with each other.

13. The static redox battery of claim 6, wherein
each of the plurality of outer frames has a concave structural surface and a convex structural surface that is a surface opposite to the concave structural surface, and further has a conductive connection portion provided at an inner edge surrounding a central opening.

14. The static redox battery of claim 13, wherein
the conductive connection portion is in contact with one of the perforated support plate and the bipolar plate, and a plurality of conductive connection portions are in close contact with each other in each of the positive electrode electrolyte storage cell module and the negative electrode electrolyte storage cell module to conduct electricity between the plurality of perforated support plates and the bipolar plate.

15. The static redox battery of claim 13, wherein
the plurality of outer frames include a first outer frame belonging to the positive electrode electrolyte storage cell module and having a first conductive connection portion, a second outer frame belonging to the negative electrode electrolyte storage cell module and having a second conductive connection portion, and a third outer frame that is in contact with the bipolar plate and having a third conductive connection portion.

16. The static redox battery of claim 15, wherein
the first outer frame includes a positive-electrode-electrolyte lower manifold introducing portion, a positive-electrode-electrolyte upper manifold introducing portion, a positive-electrode-electrolyte guide channel, a negative-electrode-electrolyte lower manifold blocking portion, and a negative-electrode-electrolyte upper manifold blocking portion.

17. The static redox battery of claim 15, wherein
the second outer frame includes a negative-electrode-electrolyte lower manifold introducing portion, a negative-electrode-electrolyte upper manifold introducing portion, a negative-electrode-electrolyte guide channel, a positive-electrode-electrolyte lower manifold blocking portion, and a positive-electrode-electrolyte upper manifold blocking portion.

18. The static redox battery of claim 15, wherein
the bipolar plate fixed to the third outer frame has one surface facing the same direction as the concave structural surface, and a negative electrode electrolyte is positioned on the one surface of the bipolar plate.

19. The static redox battery of claim 18, wherein
the bipolar plate fixed to the third outer frame has the other surface facing the same direction as the convex structural surface, and a positive electrode electrolyte is positioned on the other surface of the bipolar plate.

20. An energy storage system comprising:
the static redox battery according to claim 1;
a battery management system monitoring and managing a state of the static redox battery;
a power conditioning system receiving power from a power source and converting characteristics of electricity to store electric energy in the static redox battery and release the electric energy stored in the static redox battery to a grid; and
an energy management system electrically controlling the static redox battery and the power conditioning system.
